(19) United States
(12) Patent Application Publication
(10) Pub. No.: US 2016/0171476 A1
(43) Pub. Date: Jun. 16, 2016

(54) Mobile Application Solution for Payment (Debit and Credit) Card Validation

(71) Applicant: Shasha GUAN, Santa Ana, CA (US)

(72) Inventor: Shasha GUAN, Santa Ana, CA (US)

(21) Appl. No.: 14/800,663

(22) Filed: Jul. 15, 2015

Related U.S. Application Data
(60) Provisional application No. 62/090,262, filed on Dec. 10, 2014.

(51) Int. Cl. G06Q 20/32; G06Q 20/40

(52) U.S. Cl. CPC G06Q 20/3224; G06Q 20/4097

(57) ABSTRACT

A payment validation method includes the steps of pinging a location of a cardholder via an Internet-enabled phone thereof at a merchant before using a payment card by the cardholder to make a transaction to the merchant; sending a “head-up” notification to an acquirer to include the location of the cardholder; after submitting a payment request by the merchant to the acquirer to verify information of the payment card, performing a comparison between the location of the cardholder and a location of the merchant; and completing the transaction when the location of the cardholder matches with the location of the merchant and when the payment request is verified. The payment validation method includes user customizations, including but not limiting dollar amount and the time of day which is used to trigger additional user confirmation via the phone on the payment card transaction amount and place.

### CROSS REFERENCE OF RELATED APPLICATION

This is a non-provisional application that claims priority to U.S. provisional application, application No. 62/090,262, filed Dec. 10, 2014.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates generally to a mobile application. More specifically, the present invention is a mobile application supported system that notifies retailer and bank processors when smartphones enter cashier checkout lanes.

2. Description of Related Arts

Payment card fraud takes place every day in a variety of ways. Generally speaking, credit card or debit card fraud is a form of identity theft that involves an unauthorized taking another's payment card information and illegally using another's payment card in a transaction.

According to the most recent data (2012, US Department of Justice, “Victims of Identity Theft Report”), more than 16 million Americans have been victims of identity theft, suffering losses of more than $24 billion dollars. In 2014, security breaches led to more than 200 million individuals having their personal data stolen from such businesses as Target, JP Morgan, and Home Depot.

Most identity protection services simply wait for the user data to be stolen and then block fraudulent transactions. The problem, of course, is that the users normally are not aware that their data were stolen until much later, and when such theft has occurred, the users will need to spend the next year(s) of their life on the phone with the credit card company and the user's bank canceling their accounts and disputing the charges. Accordingly, the merchant will pay for every fraudulent transaction three times over in lost revenue, lost merchandise, and lost customer confidence.

Retailers and consumers are always looking for new ways to prevent identity fraud and credit/debit card fraud that occurs every day. It is therefore an objective of the present invention to provide a mobile application supported system that notifies retailer and bank processors when smartphones enter cashier checkout lanes.

### SUMMARY OF THE PRESENT INVENTION

The invention is advantageous in that it provides a mobile application solution for payment (debit and credit) card validation, which notifies retailer and acquirer bank processors when smartphones enter cashier checkout lanes.

Another advantage of the invention is to a mobile application solution for payment card validation, which is a security solution that works on both sides of the register. Merchants gain a new layer of protection to ensure that their loyal customers are protected on every purchase.

Another advantage of the invention is to a mobile application solution for payment card validation, wherein customer and end-users are protected everywhere they make a purchase, whether in-store or on-line.

Another advantage of the invention is to a mobile application solution for payment card validation, wherein the whole process is automated. Once the software is installed and set up, there is minimum upkeep or management required. Shoppers are notified any time a fraudulent purchase is attempted and can stop it in real-time; and merchants get purchases stopped at the point of sales, so the thieves never get away with merchant products.

Another advantage of the invention is to a mobile application solution for payment card validation, wherein the issuer (issuing bank) of the payment card will instantly confirm the location of the payment card for allowing a real-time authentication of cardholders at the time they instantly swipe their payment cards.

Another advantage of the invention is to a mobile application solution for payment card validation, which is configured as an app supported system that connects a user's phone to their credit or debit cards in order to prevent fraud. Through the use of predefined SSIDs that a user's phone detects as it enters defined aisles/areas, even in standby mode, the system of the present invention alerts users, merchants, and banks of purchases made in proximity to the phone itself.

Another advantage of the invention is to a mobile application solution for payment card validation, which timely notifies the consumer at the first occurrence if possible of credit card/identity theft. In other words, these real-time notifications allow the users or the banks to accept or reject purchases and stop fraudulent purchases as they happen, and prevent loss of revenue, inventory, and customer confidence.

Another advantage of the invention is to a mobile application solution for payment card validation, which eliminates the potential loss that might be suffered by retailers by preventing an unauthorized transaction to be processed

Another advantage of the invention is to a mobile application solution for payment card validation, which uses smartphone telecommunication network to circumvent some of the fraud risks faced by many retailers due to the vulnerability of their POS terminals.

Another advantage of the invention is to a mobile application solution for payment card validation, which is to increase the overall validity of the payment card transaction.

Another advantage of the invention is to a mobile application solution for payment card validation, wherein users can set their own parameters within which to receive notifications; whether it's by time, dollar amount, or location. Merchants can set their own parameters as well.

Additional advantages and features of the invention will become apparent from the description which follows, and may be realized by means of the instrumentalities and combinations particular point out in the appended claims.

According to the present invention, the foregoing and other objects and advantages are attained by a payment validation method, comprising the following steps.

(1) Use a payment card by a cardholder to make a transaction to a merchant.

(2) Submit a payment request, including the transaction and a merchant code of the merchant, to an acquirer to verify information of the payment card.

(3) Obtain a location of the cardholder via a mobile phone thereof to the acquirer.

(4) Send an authorization from the acquirer to an issuer of the payment card when the location of the cardholder matches with a location of the merchant.

(5) Complete the transaction through a confirmation of the issuer of the payment card.

In accordance with another aspect of the invention, the present invention comprises a method of using a mobile phone for payment validation, comprising the following steps.

(A) Install a mobile application into the mobile phone of a cardholder.

(B) Send out a location of the cardholder via the mobile phone thereof to an acquirer when using a payment card by the cardholder to make a transaction to a merchant, wherein the transaction is completed in response to the location of the cardholder and a payment request from the merchant.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow diagram of the present invention when a smartphone is present on a user.

FIG. 2 is a flow diagram of the present invention when the smartphone is not present on the user.

FIG. 3 is a flow diagram of additional validation used in the present invention.

FIG. 4 is a block diagram of the payment validation system of the present invention.

FIGS. 5A to 5E illustrate interfaces of different customization settings of the mobile application according to the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

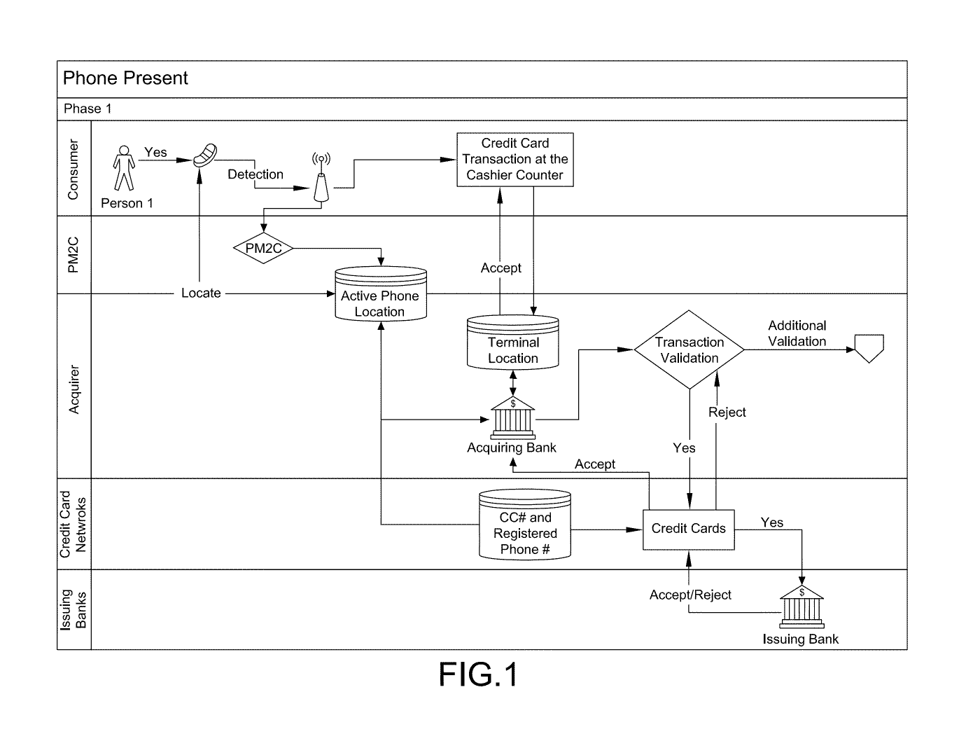

Referring to FIG. 1 of the drawings, a payment validation method according to a preferred embodiment of the present invention is illustrated. The present invention comprises a mobile application supported system that notifies retailer and bank processors when smartphones (Internet enabled phones) enter cashier checkout lanes.

According to the preferred embodiment, the payment validation method comprises the following steps.

(1) Ping a location of a cardholder via an Internet-enabled phone thereof at a merchant before using a payment card by the cardholder to make a transaction to the merchant.

The system works by transmitting the phone's location upon detection of predefined SSIDs emitted by Wi-Fi routers or SSID broadcasters located within the checkout aisles. The SSID is setup to be able to let the app know to which retailer or acquirer bank processor the location data should be transmitted to.

Accordingly, the location of the cardholder is pinged before the use of the payment card by the cardholder, i.e. a customer, to make a transaction to the merchant. The Internet enabled phone is arranged for location ping to be completed along with phone's Wi-Fi function turned on. The phone does not need to connect to the merchant wireless network, but the Wi-Fi function needs to be on so the phone is searching for nearby available wireless networks. Alternatively, the location of the cardholder is sent by the Internet enabled phone thereof to the acquirer through a merchant wireless network. In other words, the Internet enabled phone of the cardholder could login to the merchant wireless network in order to send the location of the cardholder therethrough. It is worth mentioning that when the Internet enabled phone of the cardholder logs in to the merchant wireless network, the location of the Internet enabled phone is automatically obtained. In addition, a phone notification, such as a notification for consumer verification on the purchase, will be sent from the acquirer through the merchant wireless network or consumer's mobile phone telecommunication network. Preferably, the location of the cardholder is sent by the Internet enabled phone thereof to the acquirer and an issuer (if desired) through the telecommunication network, such as 3G, 4G, or LTE network, of the Internet enabled phone.

Accordingly, when the cardholder swipes the payment card, such as credit card, debit card, or mobile payment wallet, at the cashier counter of the merchant, the cardholder is trying to make the transaction to the merchant.

(2) Send a “head-up” notification to an acquirer to include the location of the cardholder. The “head-up” notification is a notification sent from the Internet enabled phone to the acquirer to anticipate the use of the payment card. In particular, the “head-up” notification will build a database of the anticipated payment card information, such as credit number, to the acquirer right before the use of the payment card at the merchant. In other words, the “head-up” notification can serves as a pre-register notification from the cardholder to the acquirer. It is worth mentioning that when the cardholder is registered to the system of the present invention, personal information is entered in a user database of the system. Therefore, the “head-up” notification will include the personal information, such as name the payment card number, sent to the acquirer. Accordingly, the cardholder may enter two or more payment card numbers into the corresponding user database.

For example, the SSID “Any Retail Store #123-A-Processor-PM2C” would cause the app to notify the Retail Store's Processor that the phone is in its store number 123, Aisle A, while the customer is waiting in the Aisle A for checkout. This provides the processor with a “head-up” notification to anticipate the use of the credit cards registered to that phone number, thereby allowing for real-time authentication of cardholders the instant they swipe their cards.

It is worth mentioning that when the cardholder is trying to complete the transaction to the merchant after the cardholder swipes the payment card at the cashier counter of the merchant, a payment request is submitted to the acquirer to verify information of the payment card. Once the payment card is swiped, card information stored in the payment card will be sent through payment gateway (if such entity is separated from the acquirer processor), and then to the acquirer, i.e. the acquiring bank, through the terminal location thereof.

Accordingly, the payment request includes the transaction, terminal number, and a merchant code of the merchant. In particular, the merchant code includes the merchant information and the location of the merchant, wherein the terminal number will indicate the specific cashier that such transaction was processed through.

In the preferred embodiment, the present invention comes with user customization which allows consumers/individuals that downloaded the mobile application or merchants, to set alert notification(s) based on user preferences regarding dollar amount, proximity between where the phone is and the transaction terminal, and the time of day, (i.e. during night hours where users are sleeping therefore no transaction can be or should be made).

Accordingly, the cardholder can download and install the mobile application into the Internet-enabled phone, such that the location of the cardholder can be automatically sent to the acquirer via the Internet-enabled phone once the mobile application is executed. Preferably, the cardholder should register the phone number thereof to the issuer i.e. an issuing bank, such that the cardholder is able to create a user profile for the issuer. Accordingly, through the mobile application, the cardholder is able to set an alert notification regarding at least one of transaction amount, a proximal range between the locations of the Internet-enabled phone and the merchant, and a daily time usage.

It is worth mentioning that the mobile application can exist as a stand-alone mobile app. Alternatively, the mobile application can be integrated into existing apps, such as retailer apps linked to branded credit cards or card-issuing bank apps. The mobile application can also function from any app platform for any registered retailer or any credit card issuer. For example, the mobile application in “Target” app can function in “Wal-Mart” stores. The mobile application in “Bank of America” app can function for “Chase” cards. Universality across all registered retailers for all registered banks for all credit card brands, such as “Visa”, MasterCard”, “American Express”, or “Discover”. Commonality is the predefined SSID name.

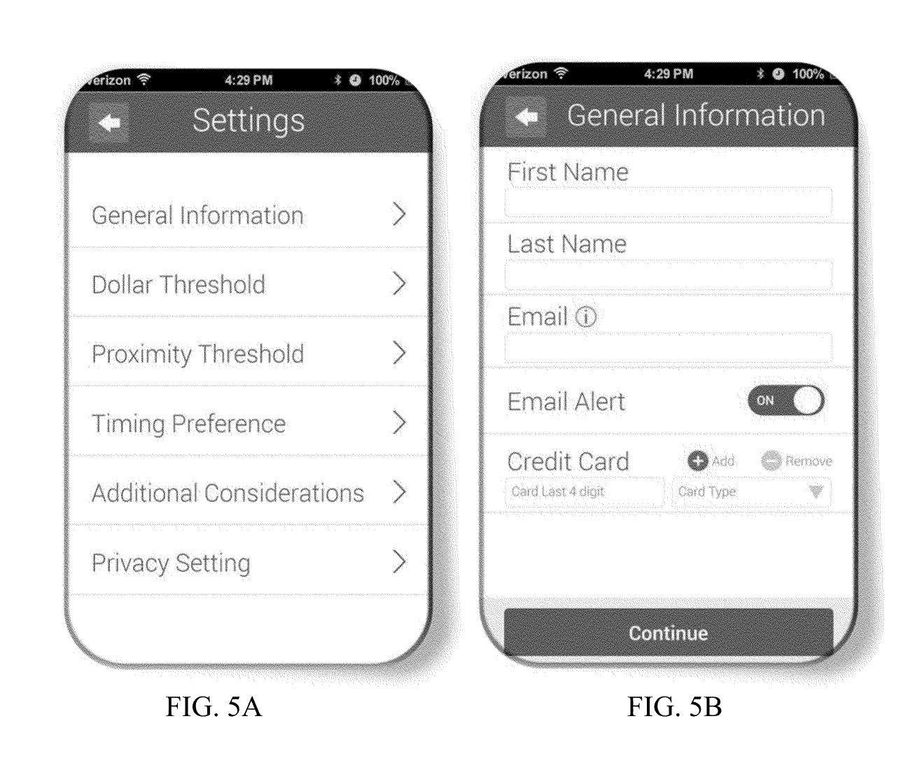

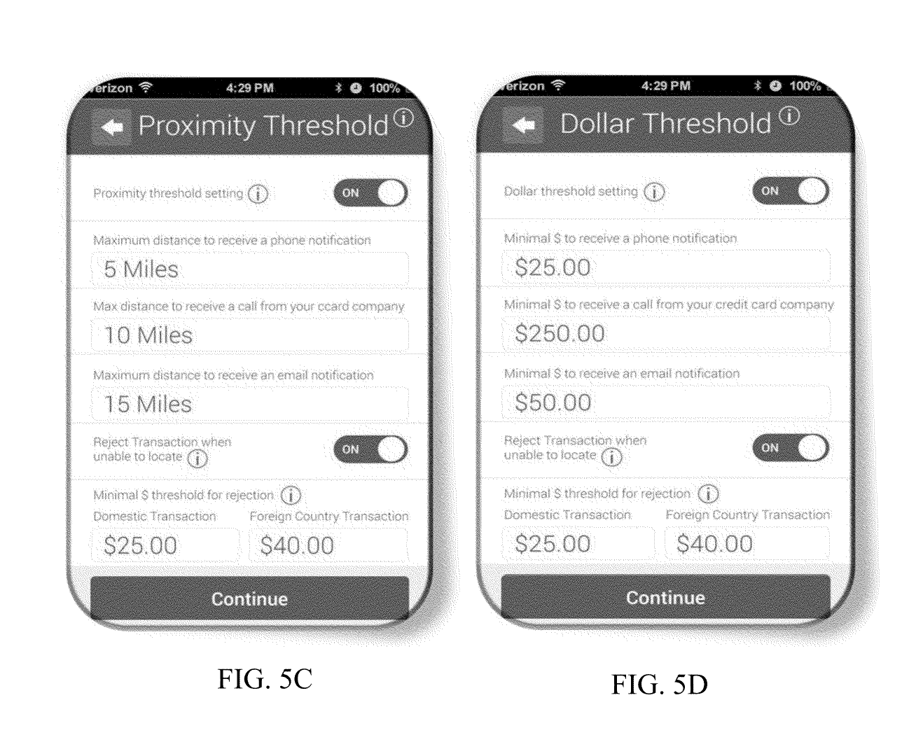

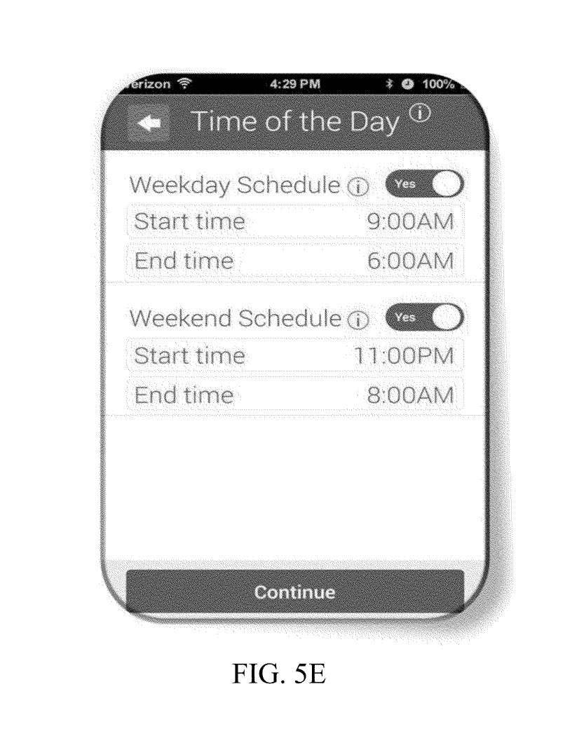

Through the mobile application, the cardholder is able to set different customization settings as shown in FIG. 5A. For example, the cardholder is able to set the name of the cardholder, email, and credit card type under general information, as shown in FIG. 5B. The cardholder is able to set a predetermined proximal range of the location of the cardholder from the merchant as shown in FIG. 5C, a dollar threshold setting as shown in FIG. 5D, and daily time usage as shown in FIG. 5E.

(3) Perform a comparison between the location of the cardholder and a location of the merchant after the payment request is submitted.

Acquirer performs the comparison between the location of the cardholder and the payment terminal location of the merchant. Accordingly, the conventional industry practice is that acquirer sends validation request to Credit Interchange to ensure the card information is valid whereas the cardholder has sufficient credit to cover for the purchase made.

Accordingly, after the cardholder swipes the credit card, as an example, the payment request will send to the acquirer from the merchant. The acquirer is able to confirm the payment request with the “head-up” notification as the pre-register notification from the cardholder to the acquirer. In particular, the acquirer is able to confirm the location of the cardholder from the “head-up” notification and the location of the merchant from the payment request.

In addition, the payment request will further include the payment card number that the cardholder swipes the payment card at the merchant. Therefore, the acquirer will also perform the comparison between the payment card number in the “head-up” notification and the payment card number in the payment request submitted from the merchant.

When the location of the cardholder does not match with the location of the merchant, the acquirer will flag the transaction as potential fraudulent and run additional screenings based on merchant and/or consumer specific user customization settings as mentioned above. In addition, an alert message will send to the Internet-enabled phone of the cardholder, the acquirer, and/or the issuer. When the card information is qualified and the location of the cardholder matches with the location of the merchant, the acquirer will accept the transaction.

(4) Complete the transaction through a confirmation of the acquirer of the payment card. Once the acquirer accepts the transaction, sales receipt will generate at the cashier register, the sales is considered final and individual customers can walk out the door with their purchases. It is worth mentioning that no signature is needed from the cardholder to the merchant in order to complete the transaction.

(5) Record all the transactions in the Internet-enabled phone of the cardholder. Accordingly, once the transaction is completed, data of the transaction, such as dollar amount, date, place, and transaction time, can be saved upon user choice in the Internet-enabled phone of the cardholder.

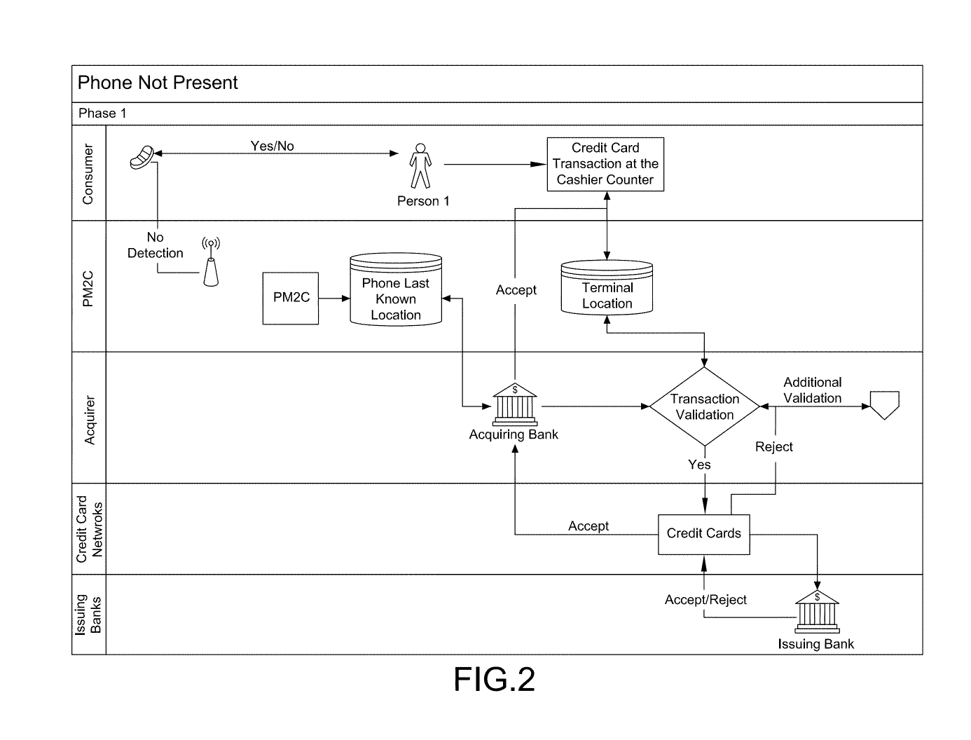

FIG. 2 illustrates an alternative mode of the present invention, wherein there is no detection of the location of the mobile phone of the cardholder. In case the current location of the cardholder cannot be sent by the mobile phone thereof to the acquirer, the location of the mobile phone of the cardholder is obtained by the last known location thereof. Accordingly, the last known location of the Internet-enabled phone must be within a predetermined proximal range of the location of the merchant, such as less than 1 mile, the acquirer will accept the transaction. In other words, when there is no reception of the Internet-enabled phone, the acquirer can obtain the last known location of the Internet-enabled phone to verify the reasonableness of the payment card information.

Alternatively, when the Internet-enabled phone of the cardholder is unable to be pinged, a message is sent to the Internet-enabled phone of the cardholder for verification. The message can be a voice call and/or a text message to the cardholder.

The cardholder will sent back a confirmation reply from the Internet-enabled phone of the cardholder regarding to the message. If there is no reply, the transaction cannot be completed unless otherwise noted through user setting. Current system allows user to define transaction timeout period and consequent actions. For example, user can choose a timeout period of 30 seconds and consequent action of either automatically accept or decline the transaction. In addition, the cardholder can deny the transaction through the message. The transaction may be automatically rejected when the cardholder is unable to locate through the user setting. It is worth mentioning that the location of the Internet-enabled phone of the cardholder can be automatically obtained through the user confirmation reply.

It is worth mentioning that the location of the merchant must be within the preset proximal range of the last known location of the Internet-enabled phone in order to process the transaction.

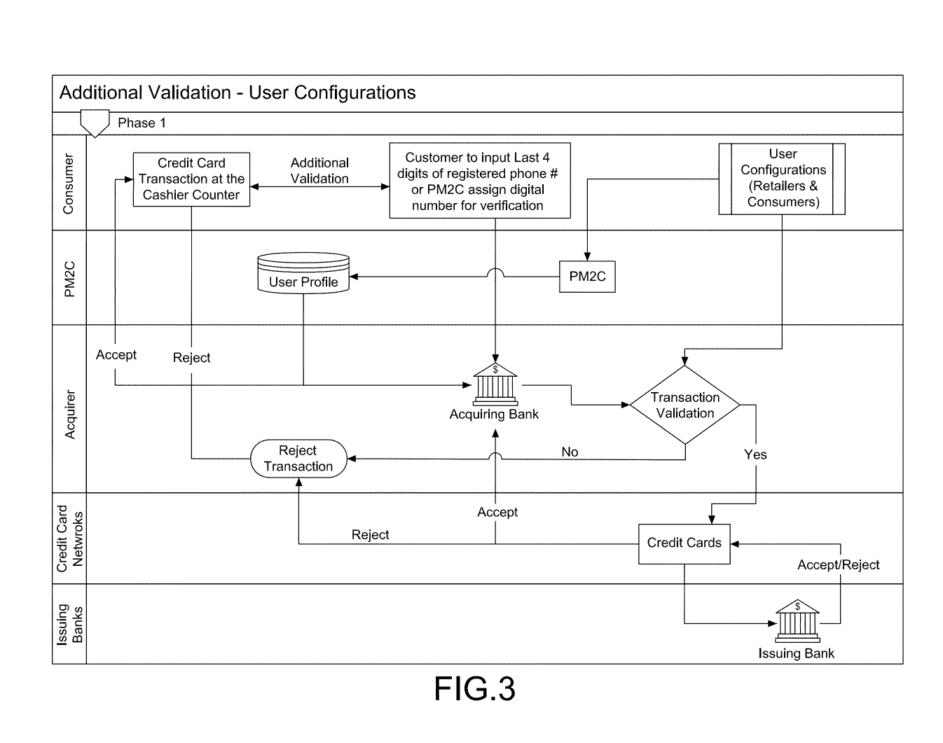

FIG. 3 illustrates an additional validation for the cardholder, wherein when the location of the cardholder is obtained, the cardholder will obtain a customer code by the merchant to the acquirer. In other words, the customer code is generated by the Internet-enabled phone and the cardholder will enter the customer code to submit to the acquirer. Accordingly, the customer code is a verification code to further ensure the use of the payment card by the cardholder. The customer code can be a sequence of digits in response to a phone number of the cardholder, such as the last 4 digits of the mobile phone number. Alternatively, the customer code can be a sequence of digits assigned to send to the Internet-enabled phone of the cardholder. The customer code can be randomly generated via the mobile application. For example, when the mobile application will generate the customer code as “1543”, the cardholder must enter “1543” through the Internet-enabled phone and submits to the acquirer. It is worth mentioning that the cardholder can deny the transaction after receiving the customer code. Likewise, when the acquirer does not receive the customer code from the cardholder for a predetermined time frame, such as 5 minutes, or the acquirer receives a wrong customer code, the transaction will be rejected.

In order to operate the present invention, the cardholder is able to install the mobile application into the Internet-enabled phone thereof, such that the cardholder is able to register the phone number via the Internet-enabled phone. When using the payment card to make a transaction to the merchant, the cardholder is able to send out the location of the Internet-enabled phone to the acquirer and the issuer through the telecommunication network or the merchant wireless network.

It is worth mentioning that once the location of the cardholder is obtained, merchant information, such as promotion or coupon, can be automatically sent to the Internet-enabled phone. In particular, when the location of the cardholder is pinged at the check-out aisle of the merchant, the corresponding merchant information will be sent to the cardholder, such that the cardholder is able to obtain any coupon or other promotion items when he or she is waiting for check out. It is worth mentioning that through the payment validation system of the present invention, the cardholder is able to obtain different merchant information within the proximal range of the location of the cardholder.

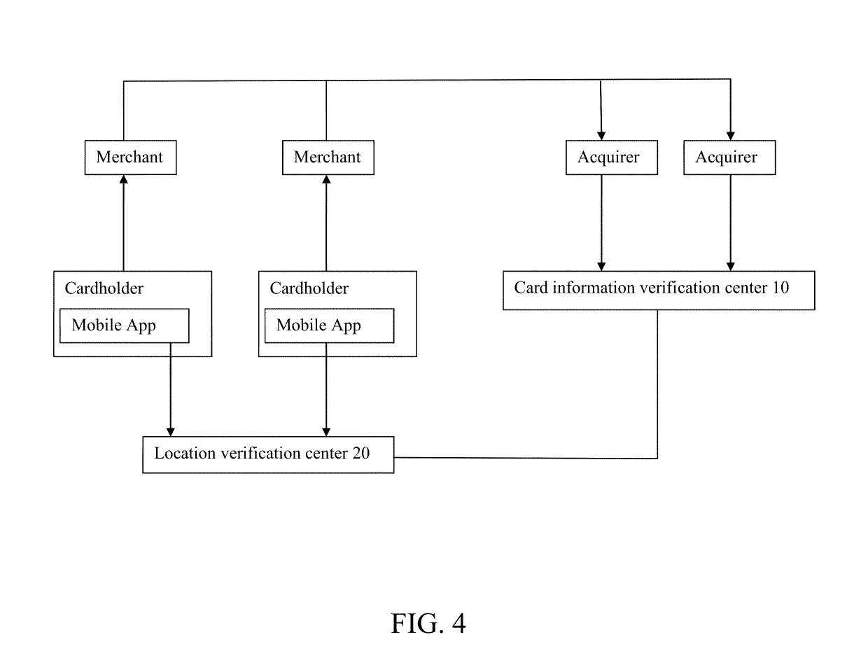

FIG. 4 illustrates the payment validation system of the present invention, which comprises, the mobile application adapted to be installed into the Internet-enabled phone of the cardholder, a card information verification center 10 for verifying information of the payment card of the cardholder and a location verification center 20 operatively linked to the card information verification center 10 for verifying the location of the mobile phone of the cardholder.

Accordingly, the payment validation system can be implemented in the issuer's system to confirm the transaction among the cardholder, the merchant, and the acquirer. The card information verification center 10 is operatively linked to the acquirer to receive the authorization from the acquirer. It is worth mentioning that the authorization includes information of the acquirer, the transaction and the merchant code to show the location of the merchant.

In particular, the mobile application is installed into the Internet-enabled phone of a cardholder for pinging the location of the cardholder via the Internet-enabled phone thereof at the merchant before using the payment card by the cardholder to make a transaction to the merchant. In addition, the mobile application generates the “head-up” notification for sending to the acquirer to include the location of the cardholder. The mobile application is always activated for enabling the Internet-enabled phone to search for nearby available wireless networks around the cardholder.

The location verification center 20 is a computerized module incorporating with a system of the acquirer. The location verification center 20 is arranged to receive a location data of the Internet-enabled phone. In particular, the location verification center 20 will receive the “head-up” notification from the cardholder for performing a comparison between the location of the cardholder and the location of the merchant in order to process the transaction when the location of the cardholder matches with the location of the merchant. The location verification center 20 will also perform the comparison between the payment card number in the “head-up” notification and the payment card number in the payment request submitted from the merchant.

The location verification center 20 further generates the message for being sent to the Internet-enabled phone of the cardholder when the Internet-enabled phone of the cardholder is unable to be pinged, and receives a confirmation reply from the Internet-enabled phone of the cardholder regarding to the message in order to obtain the location of the Internet-enabled phone of the cardholder in response to the confirmation reply.

Accordingly, the payment validation system recognizes when the Internet-enabled phone enters the merchant, especially at the checkout aisle, provides an advance “head-up” notification to the acquirer, and allows a real-time virtual validation of cardholders. For online e-commerce, the payment validation system allows for location-acquisition text confirmation/triangulation on the phone location for transaction confirmation, and allows for timely detection of suspicious activity. The payment validation system can stop fraud after first incident rather than multiple incidents or when the payment card credit limit is maxed out.

Therefore, the payment validation system will help the acquirer to verify the card information of the cardholder and the location thereof. As it is mentioned above, when the card information is qualified and the location of the cardholder matches with the location of the merchant, the acquirer will accept the transaction and will send the confirmation to the acquirer to complete the transaction.

In case the cardholder does not install the mobile applicant in the phone, the merchant is able to submit the phone number of the cardholder to the location verification center 20, such that the message, such as the text message, is sent to the phone of the cardholder for transaction confirmation. In case the cardholder does not install the mobile applicant in the phone and the merchant does not have the phone number of the cardholder, the merchant is able to submit the first name, last name, and location of the merchant, such that the location verification center 20 is able to look up the phone number of the location verification center 20 from the user database and to send the message to the phone of the cardholder for transaction confirmation. It is worth mentioning that the location verification center 20 is able to look up the phone number of the cardholder based on the name thereof or to look up the name of the cardholder based on the phone number thereof. If the cardholder does not have the Internet-enabled phone, the location verification center 20 is able to use triangular cellular towers to approximate any phone location.

The solution goals of the present invention are as follows: (1) timely notify consumer at the first occurrence if possible of credit card/identity theft, (2) eliminate the potential loss that might be suffered by retailers by preventing an unauthorized transaction to be processed, (3) use smartphone telecommunication network to circumvent some of the fraud risks faced by many retailers due to the vulnerability of their POS terminals, and (4) to increase the overall validity of the payment card transaction.

In view of the acquirer, such as the acquiring bank or credit associations, the payment validation system will provide additional value-added-service to its customers for a per transaction fee. In view of the issuer, such as the issuing bank, the payment validation system will prevent costly fraudulent transactions, provide credit protection to its cardholders, and share the credit risk exposure with individual customers. In view of the individual consumers, the payment validation system will protect one's own identity information, have visibility to one's own payment card transactions, and have control over one's own credit risk. For the merchants, such as retailers, the payment validation system will prevent merchandise loss, reduce payment cards fees (such as charge-back), retain consumer confidence, and diminish the value of credit information already obtained by hackers.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A payment validation method, comprising the steps executed by a computerized unit of:
(a) pinging a location of a cardholder via an Internet-enabled phone thereof at a merchant before using a payment card by the cardholder to make a transaction to the merchant;
(b) sending a “head-up” notification to an acquirer to include the location of the cardholder;
(c) after submitting a payment request by the merchant to the acquirer to verify information of the payment card, performing a comparison between the location of the cardholder and a location of the merchant; and
(d) completing the transaction when the location of the cardholder matches with the location of the merchant and when the payment request is verified.

2. The method, as recited in claim 1, wherein the step (a) further comprises the steps of:
when the Internet-enabled phone of the cardholder is unable to be pinged, obtaining the location of the Internet-enabled phone of the cardholder by the last known location thereof; and
determining whether the last known location of the Internet-enabled phone of the cardholder within a predetermined proximal range of the location of the merchant.

3. The method, as recited in claim 2, wherein the transaction is completed when the location of the cardholder is within predetermined proximal range of the location of the merchant.

4. The method, as recited in claim 1, wherein the step (a) further comprises the steps of:
(a.1) when the Internet-enabled phone of the cardholder is unable to be pinged, sending a message to the Internet-enabled phone of the cardholder;
(a.2) receiving a confirmation reply from the Internet-enabled phone of the cardholder regarding to the message;
(a.3) obtaining the location of the Internet-enabled phone of the cardholder in response to the confirmation reply.

5. The method, as recited in claim 1, wherein the step (a) further comprises a step of transmitting a phone's location upon detection of predefined SSIDs emitted by Wi-Fi routers or SSID broadcasters located within the merchant in order to ping the location the Internet-enabled phone of the cardholder.

6. The method as recited in claim 1 wherein, in the step (a), the location of the cardholder is sent by the Internet-enabled phone thereof to the acquirer through a telecommunication network of the Internet-enabled phone.

7. The method, as recited in claim 1, before the step (a) further comprising an app controlling step of installing a mobile application into the Internet-enabled phone of the cardholder in order to ping the location of the cardholder to the acquirer via the Internet-enabled phone.

8. The method, as recited in claim 7, wherein the app controlling step further comprises a step of setting an alert notification regarding one of transaction amount, a proximal range between the locations of the Internet-enabled phone and the merchant, and a daily time usage.

9. The method, as recited in claim 1, further comprising a register step of registering a phone number of the cardholder to the issuer.

10. The method, as recited in claim 1, further comprising a step of obtaining a customer code from the cardholder to the acquirer.

11. The method, as recited in claim 10, wherein the customer code is a sequence of digits in response to a phone number of the cardholder.

12. The method, as recited in claim 10, wherein the customer code is a sequence of digits assigned to send to the Internet-enabled phone of the cardholder.

13. A method of using an Internet-enabled phone for payment validation, comprising the steps executed by a computerized unit of:
(a) executing a mobile application in the Internet-enabled phone of a cardholder after the mobile application is downloaded and installed into the Internet-enabled phone of the cardholder; and
(b) pinging a location of the cardholder via the Internet-enabled phone thereof at a merchant before using a payment card by the cardholder to make a transaction to the merchant, wherein the transaction is completed in response to the location of the cardholder and a location the merchant.

14. The method, as recited in claim 13, wherein the step (a) further comprises a step of setting an alert notification regarding one of transaction amount, a proximal range between the locations of between the Internet-enabled phone and the merchant, and a daily time usage.

15. The method, as recited in claim 13, wherein the step (a) further comprises a step of transmitting a phone's location upon detection of predefined SSIDs emitted by Wi-Fi routers or SSID broadcasters located within the merchant in order to ping the location the Internet-enabled phone of the cardholder.

16. The method, as recited in claim 13, wherein the step (b) further comprises the steps of:
(b.1) when the Internet-enabled phone of the cardholder is unable to be pinged, sending a message to the Internet-enabled phone of the cardholder;
(a.2) receiving a confirmation reply from the Internet-enabled phone of the cardholder regarding to the message;
(a.3) obtaining the location of the Internet-enabled phone of the cardholder in response to the confirmation reply.

17. A payment validation system, comprising:
a mobile application adapted for being installed into an Internet-enabled phone of a cardholder and for pinging a location of a cardholder via the Internet-enabled phone thereof at a merchant before using a payment card by the cardholder to make a transaction to the merchant, wherein the mobile application generates a “head-up” notification for sending to an acquirer to include the location of the cardholder; and
a location verification center, which is arranged for incorporating with a system of the acquirer, receiving the “head-up” notification from the cardholder and performing a comparison between the location of the cardholder and a location of the merchant in order to process the transaction when the location of the cardholder matches with the location of the merchant.

18. The payment validation system, as recited in claim 17, wherein the location verification center further generates a message for being sent to the Internet-enabled phone of the cardholder when the Internet-enabled phone of the cardholder is unable to be pinged, and receives a confirmation reply from the Internet-enabled phone of the cardholder regarding to the message in order to obtain the location of the Internet-enabled phone of the cardholder in response to the confirmation reply.

19. The payment validation system, as recited in claim 17, wherein the mobile application is always activated for enabling the Internet-enabled phone to search for nearby available wireless networks around the cardholder.

20. The payment validation system, as recited in claim 17, wherein the mobile application provides an alert notification regarding one of transaction amount, a proximal range between the locations of the Internet-enabled phone and the merchant, and a daily time usage.
